(19) United States
(12) Patent Application Publication
(10) Pub. No.: US 2013/0222650 A1
(43) Pub. Date: Aug. 29, 2013

(54) Copying Device that Converts Images on Films into Digital Images

(71) Applicant: Chene Nan Hong, Changhua City (TW)

(72) Inventor: Chene Nan Hong, Changhua City (TW)

(21) Appl. No.: 13/693,254

(22) Filed: Dec. 4, 2012

(30) Foreign Application Priority Data
Feb. 29, 2012 (CN) 201220070367.7

(51) Int. Cl. G02B 15/00

(52) U.S. Cl. CPC G02B 15/00
USPC 348/240.3

(57) ABSTRACT

A copying device that converts images on films to digital images has a film clip slot between the top and bottom thereof for the insertion of a film. The body thereof has a zooming optical lens group for an electronic device to copy the film on a film clip.

### BACKGROUND OF THE INVENTION

This application claims the benefit of CN 201220070367.7 filed on Feb. 29, 2012 in the State Intellectual Property Office of the People's Republic of China, the specification of which is incorporated in its entirety by reference.

### FIELD OF INVENTION

The invention relates to a digital image processing auxiliary device and, in particular, to a copying device that converts images on films into digital images.

### RELATED ART

Photography in early days used films as the photosensitive element. Therefore, images are preserved through the films or printed out as photos. Both films and photos are likely to age and deteriorate after a long time. Therefore, it is very difficult and inconvenient to keep them. With the popularization of computers and digital cameras, more and more people need to convert films and photos into digital images.

Devices on the market that convert films and photos into digital images are mainly scanners and film duplicators. These require professional lenses and connection with a computer in order to capture the images. The shooting cost is thus higher. It is also inconvenient to carry so many devices.

### SUMMARY OF THE INVENTION

An objective of the invention is to solve the above-mentioned problems by providing a duplicating device that converts images on films into digital images. The invention makes use of a smart phone or tablet computer to copy the film and store digital images. It has the advantages of lower shooting cost and convenience in carrying.

Another objective of the invention is to provide a copying device that can copy images on both films and photos.

To achieve the above-mentioned objectives, the invention includes: a body, a film clip, and a zooming optical lens group.

The top of the body has a positioning part for the fixture of an electronic device with lenses. A film clip slot is formed between the top and bottom thereof The center of the film clip groove has a hole.

The film clip is provided for the positioning of a film and is inserted into the film clip slot. It has several linearly arranged intervals for simultaneously positioning several films.

The zooming optical lens group is disposed in the body and aligned with the film clip. The portion focused by the zooming optical lens group has a backlit element to be the light source of the film. The lens of the electronic device is positioned by the fixing part and is coaxial in the longitudinal direction with the zooming optical lens group. The zooming optical lens group is then used to copy the film disposed in front of the backlit element.

The invention further includes a photo clip, an illuminating unit, and a wide-angle optical lens group. The bottom of the body has a photo clip slot. The photo clip positions a photo and is inserted into the photo clip slot. The illuminating unit has a lighting tube and a reflector. The reflector is disposed around the photo clip to redirect the light emitted by the lighting tube toward the photo clip. The wide-angle optical lens group is disposed in the body and aligned with the photo clip. The lens of the electronic device is positioned by the fixing part and is coaxial in the longitudinal direction with the wide-angle optical lens group. The wide-angle optical lens group is then used to copy the photo disposed at the photo clip.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional exploded view of the invention;

FIG. 2 is a schematic view of the invention showing that the first positioning element positions a smart phone on the body;

FIG. 3 is a schematic view of the invention showing that the second positioning element positions a tablet computer on the body;

FIG. 4 is a schematic side view of the body in the direction of the supporting device;

FIG. 5 is a schematic side view of the body in the direction of the wide-angle optical lens group and the zooming optical lens group;

FIG. 6 is another schematic side view of the body in the direction of the wide-angle optical lens group;

FIG. 7 is an enlarged schematic view of the zooming optical lens group; and

FIG. 8 is an enlarged schematic view of the wide-angle optical lens group.

### DETAILED DESCRIPTION OF THE INVENTION

The present invention will be apparent from the following detailed description, which proceeds with reference to the accompanying drawings, wherein the same references relate to the same elements.

The invention provides a copying device that converts images on films into digital images. An embodiment of the invention includes: a body 1, a photo clip 2, a film clip 3, an illuminating unit 4, a wide-angle optical lens group 5, and a zooming optical lens group 6.

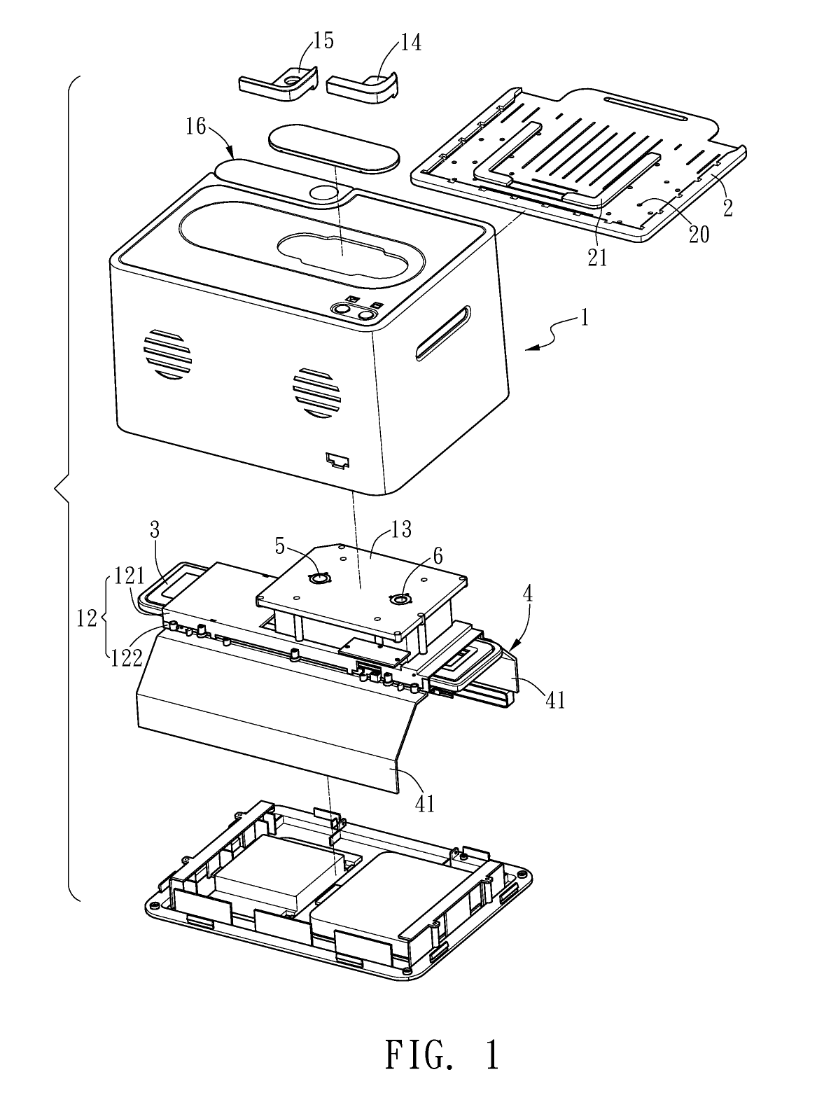

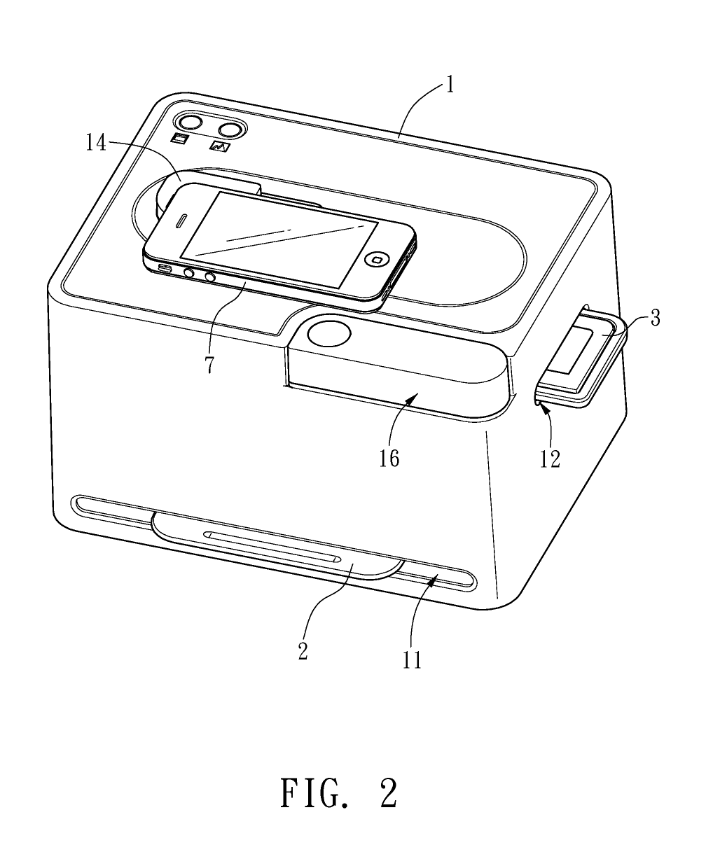

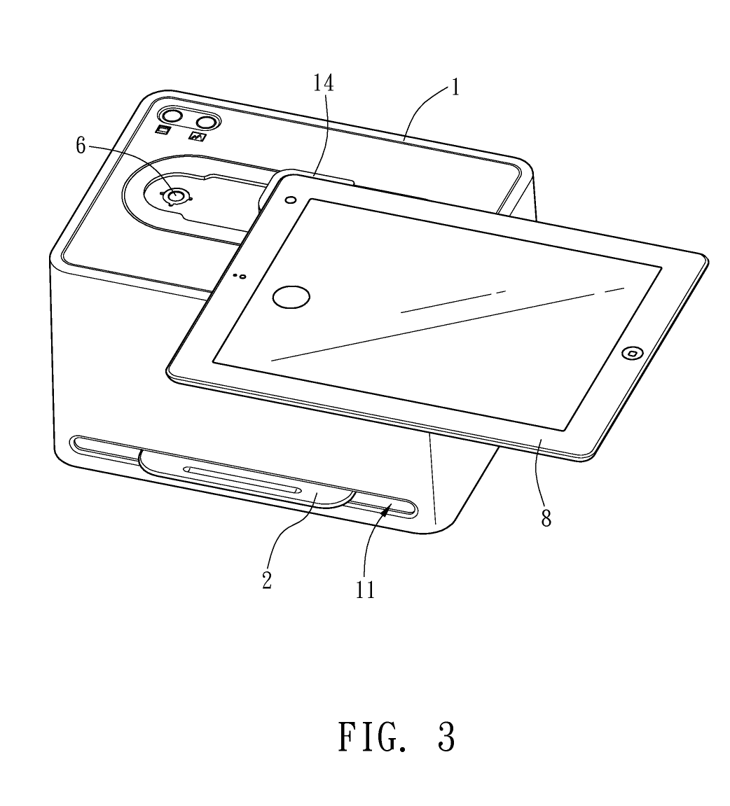

As shown in FIGS. 1 to 3, the top of the body 1 has a positioning part to fix an electronic device with a lens. The bottom of the body 1 has a photo clip slot 11. A film clip slot 12 is formed between the top and bottom. The film clip slot 12 in this embodiment is formed by connecting an upper rail 121 and a lower rail 122 on the main body 1. The middle of the film clip slot 12 has a hole 123. In this embodiment, the electronic device can be a smart phone 7 or tablet computer 8. The body 1 has a positioning board 13 under the positioning part when shooting. The positioning part of this embodiment includes a first positioning element 14 and a second positioning element 15. As shown in FIG. 2, the first positioning element 14 corresponds to the frame on the smart phone 7 for the lens. As shown in FIG. 3, the second positioning element 15 corresponds to the frame on the tablet computer 8 for the lens.

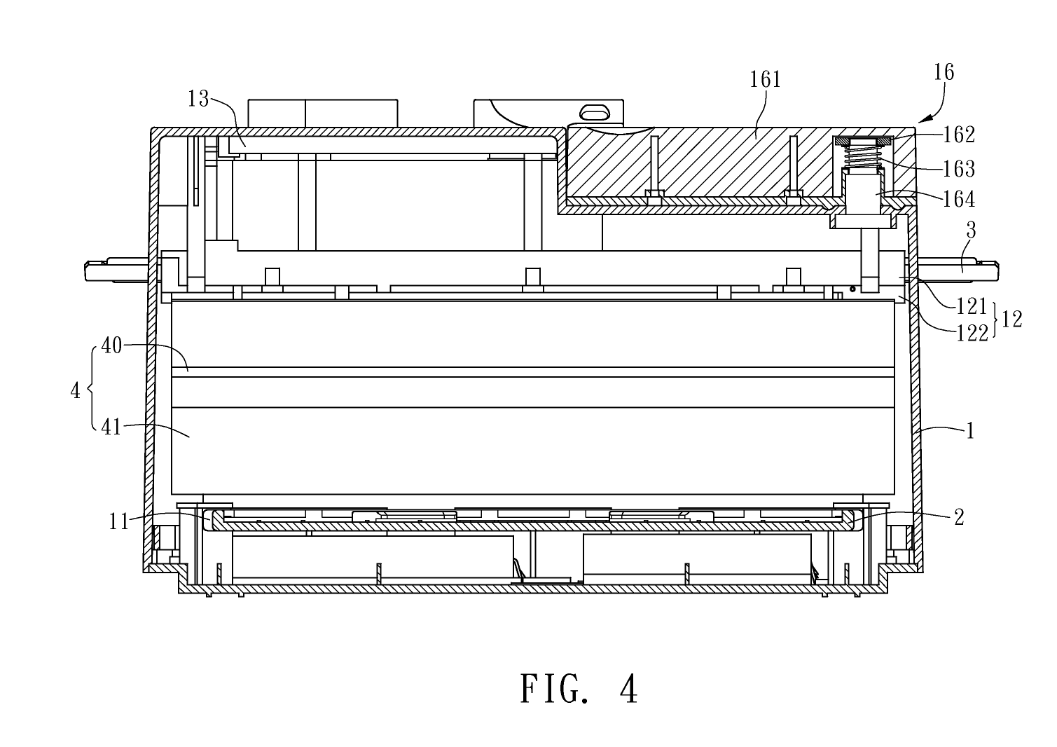

As shown in FIG. 4, the body 1 is further provided with a support device 16 on one side of the top of the body 1, including a support plate 161, a support pad 162, a support spring 163, and a support frame rotation shaft 164. The support spring 163 is mounted on the support frame rotation shaft 164. The support pad 162 is disposed between the support frame rotation shaft 164 and the support plate 161. The support plate 161 can protrude or retract with respect to the body 1. When the electronic device is a tablet computer 8 whose screen panel width is greater than that of a smart phone 7, the support plate 161 is put out to support the tablet computer 8.

As shown in FIG. 1, the photo clip 2 is provided mainly to position a photo and is inserted into the photo clip slot 11. The film clip 3 is provided to position a film and is inserted into the film clip slot 12. The film clip 3 has several linearly arranged intervals for simultaneously positioning several films. The photo clip 2 in this embodiment has a magnet 20 and an L-shaped fixing plate 21. The fixing plate 21 is attracted onto the magnet 20 to fix the photo. The fixing plate 21 has a size that fits the photo, such as 4 in.×6 in., 3 in.×5 in., or a business card.

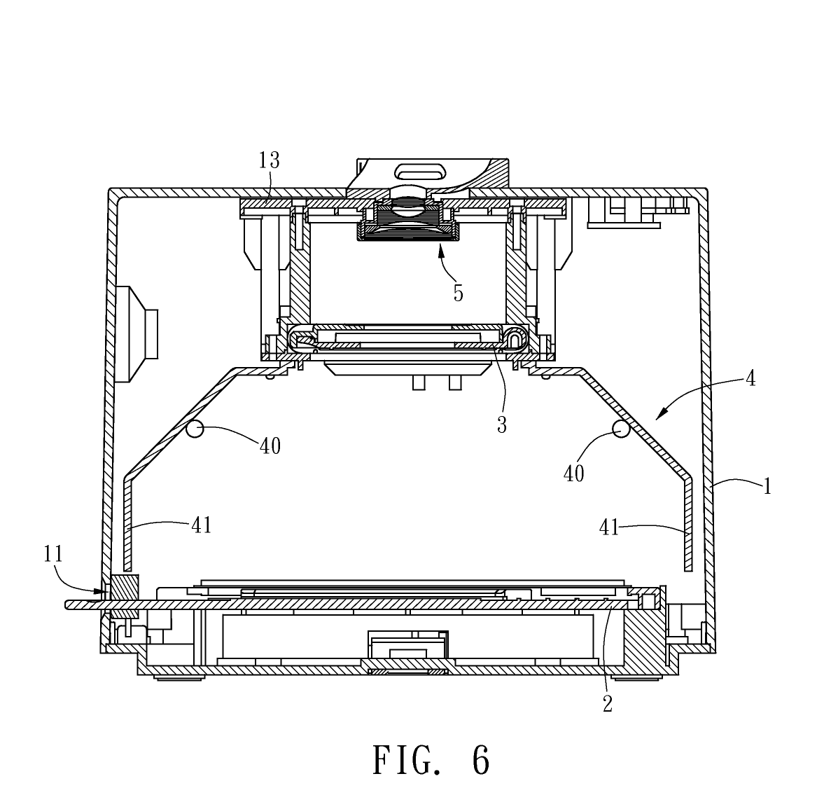

As shown in FIGS. 1, 5 and 6, the illuminating unit 4 has a lighting tube 40 and reflectors 41. The reflectors 41 are disposed around the photo clip 2 to direct the light emitted by the illuminating tube 40 toward the photo clip 2. The light emitted by the illuminating tube 40 is thus spread over a wider range and more uniformly onto the photo to be copied. This ensures the quality of photocopying.

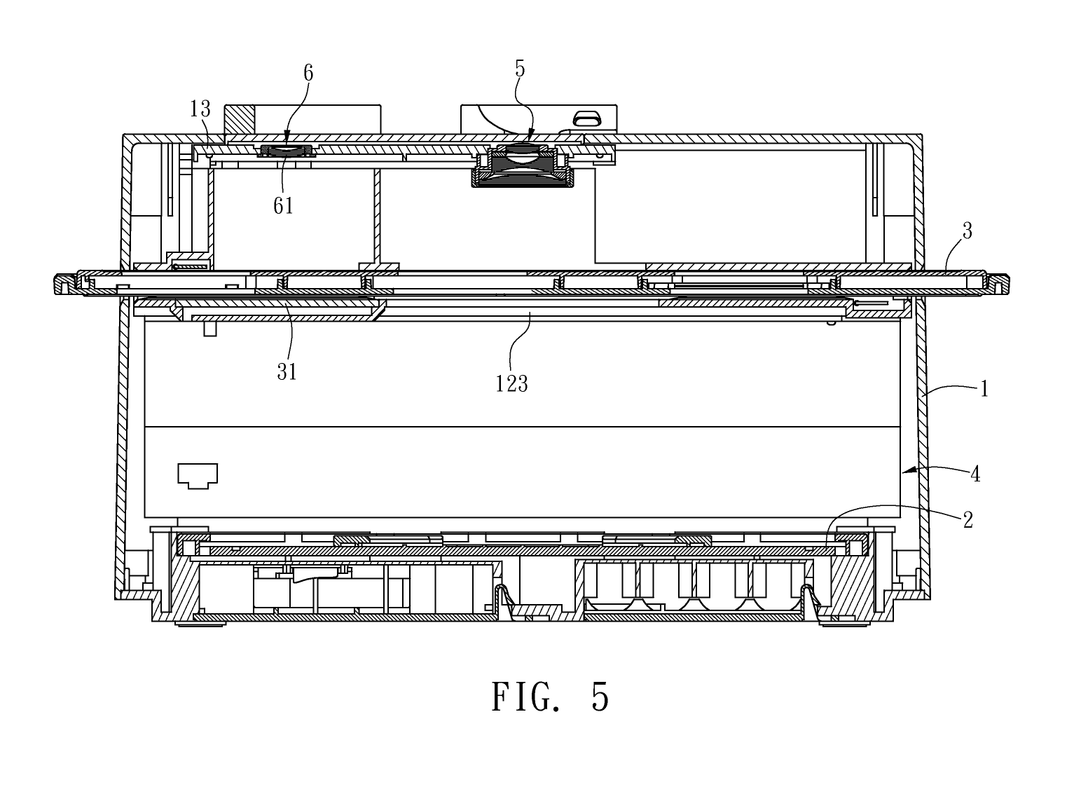

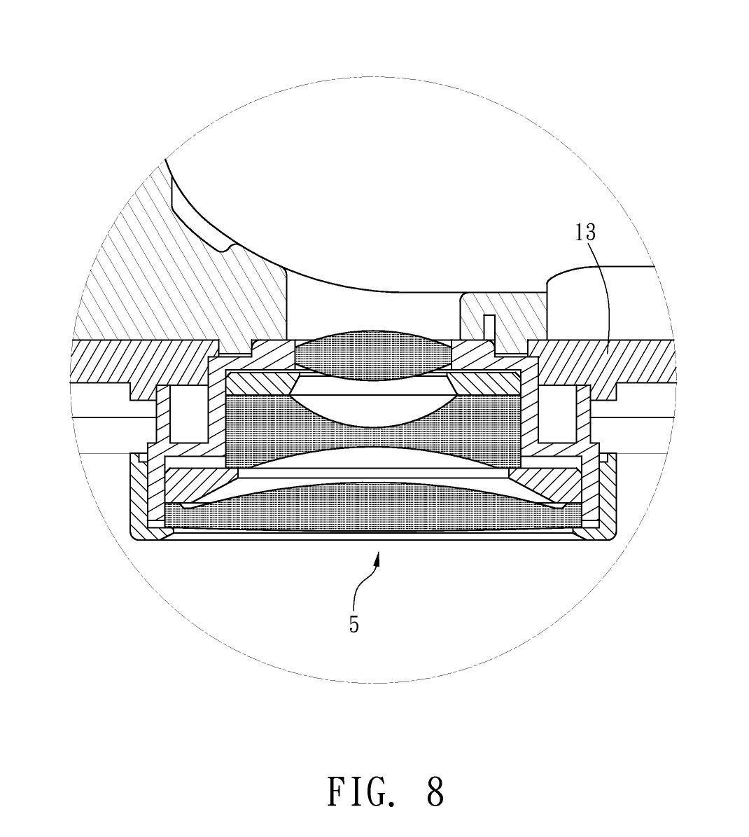

As shown in FIGS. 5 and 8, the wide-angle optical lens group 5 is disposed in the body 1 and aims at the photo clip 2. The above-mentioned lens is positioned by the fixing part and coaxial in the longitudinal direction with the wide-angle optical lens group 5. The photo on the photo clip 2 is then copied via the wide-angle optical lens group 5. In this embodiment, the wide-angle optical lens group 5 is disposed on the positioning board 13.

Please refer to FIGS. 5 to 7. The zooming optical lens group 6 is disposed in the body 1 and aims at the film clip 3. The portion aimed by the zooming optical lens group 6 has a backlit element as the light source of the film. The backlit element in this embodiment is a backlit board 31 disposed in the lower rail 122 and under the film. The light emitted by the lighting tube 40 is then directed toward the film. The above-mentioned lens is positioned by the fixing part and coaxial in the longitudinal direction with the zooming optical lens group 6. The film on the backlit board 31 is then copied via the zooming optical lens group 6. In this embodiment, the zooming optical lens group 6 is also disposed on the positioning board 13.

The wide-angle optical lens group 5 aligns with the lens of an electronic device such as a smart phone or tablet computer. The focal length is shortened by 10%-20%. The field angle changes from 66±2 degrees to 80±20 degrees. The aberration is within ±10%. This allows the electronic device to take a photo of size 7 in.×5 in. at a smaller distance of 128±20 mm than the original 168 mm. This greatly reduces the volume of the copying device.

The zooming optical lens group 6 in this embodiment aligns with the lens of an electronic device such as a smart phone or tablet computer. The focal length is extended by 0.35±0.2 mm. The field angle changes from 66 degrees down to 48±5 degrees. The electronic device is thus able to take a clear image on the film of size 36 mm×24 mm at a distance of 41±5 mm from the film.

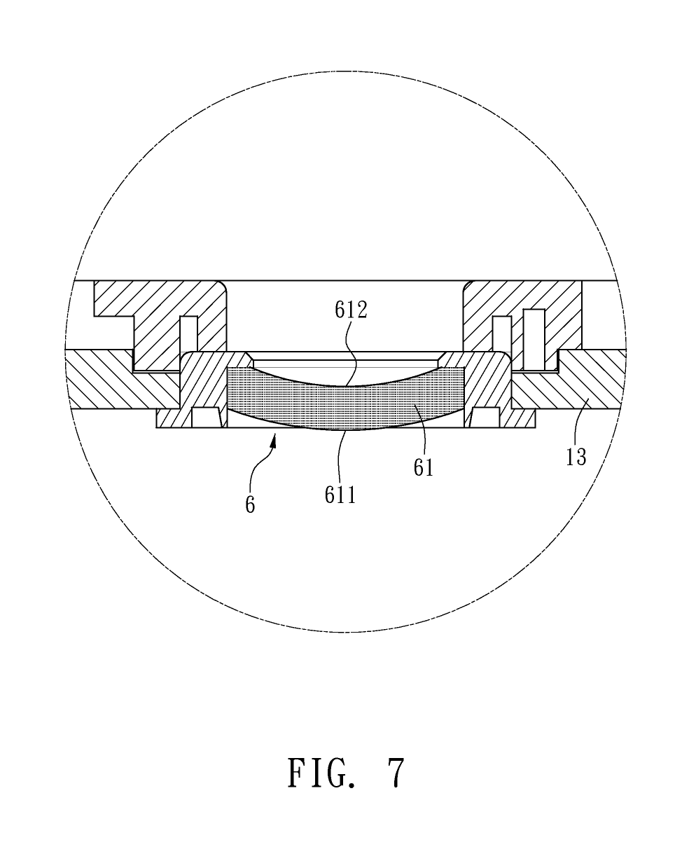

With reference to FIG. 7, the wide-angle optical lens group 5 consists of spherical or non-spherical lenses. The zooming optical lens group 6 consists of spherical lenses 61. In this embodiment, the zooming optical lens group 6 is a spherical lens 61, a convex-concave lens with double spherical surfaces. The first spherical surface 611 has an R value of 8-80 mm, and the second spherical surface 612 has an R value of 8-80 mm. The central thickness is 0.5-5 mm, and the focal length is 30-90 mm (53.4 mm in the current embodiment). This convex-concave lens with double spherical surfaces is designed according to the focal length formula F=N*R1*R2/(N−1){N(R2−R1)+(N−1)D}, where F is the focal length, N is the index of refractivity nd of the lens, D is the central thickness thereof, and R1 and R2 are respectively the radii of the two spherical surfaces thereof.

The wide-angle optical lens group 5 and the zooming optical lens group 6 are correctly connected to the lens of the electronic device so that images can be completely formed by the wide-angle optical lens group 5 and the zooming optical lens group 6 without dark corners or unclear parts. It can keep more than 95% of the pixels in the original image.

When copying a photo, one fixes the photo on the photo clip 2 with the fixing plate 21 and inserts the photo clip 2 into the photo clip slot 11. In this case, the film clip 3 has to be withdrawn from the film clip slot 12 so that the hole 123 at the center of the film clip slot 12 is exposed. The illuminating unit 4 then illuminates the photo on the photo clip 2. The lens of the electronic device is aligned with the wide-angle optical lens group 5 to copy the photo on the photo clip 2 via the hole 123.

When copying a film, one inserts the film clip 3 into the film clip slot 12 on the body 1 and slides the film clip 3 until the film on some interval is above the backlit board 31 and under the zooming optical lens group 6. The film in this interval can then be copied. To copy the film in some other interval, one further slides the film clip 3 to move that film over the backlight board 31.

It is apparent that the invention has the following advantages. Using the disclosed copying device, one can use an electronic device such as a smart phone or tablet computer to copy a film or photo and convert it into a digital image for storage. Since smart phones and tablet computers are very popular, copying films does not require one to purchase professional photography equipment. They are also portable. In addition to copying films, the disclosed copying device can also copy photos.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. A copying device that converts images on films and photos into digital images, comprising:
a body having a positioning part at the top thereof to fix an electronic device with a lens, a film clip slot between the top and bottom thereof, and a hole in the middle of the film clip slot;
a film clip for positioning a film, to be inserted into the film clip slot, and having a plurality of intervals arranged in a line to simultaneously position a plurality of films;
a zooming optical lens group disposed in the body and aligned with the film clip;
wherein the portion aimed at by the zooming optical lens group has a backlit element under the film as a light source for the film; the lens of the electronic device is positioned by the fixing part and coaxial in the longitudinal direction with the zooming optical lens group; and the film disposed on the backlit element is copied via the zooming optical lens group.

2. The copying device of claim 1 further comprising a photo clip, an illuminating unit, and a wide-angle optical lens group; wherein the bottom of the body has a photo clip slot; the photo clip positions a photo and is inserted into the photo clip slot; the illuminating unit has a lighting tube and reflectors; the reflectors are disposed around the photo clip to redirect light emitted by the lighting tube toward the photo clip; the wide-angle optical lens group is disposed in the body and aligned with the photo clip; the lens of the electronic device is positioned by the fixing part and coaxial in the longitudinal direction with the wide-angle optical lens group; and the photo disposed on the photo clip is copied via the wide-angle optical lens group.

3. The copying device of claim 1, wherein the film clip slot is formed by connecting an upper rail and a lower rail on the body, and the backlit element is disposed in the lower rail.

4. The copying device of claim 1, wherein the body has a support device on one side of the top thereof, including a support board, a support pad, a support spring, and a support frame rotation shaft; the support spring is mounted on the support frame rotation shaft; the support pad is disposed between the support frame rotation shaft and the support pad; the support board protrudes or retracts with respect to the body and supports the electronic device when protruded from the body.

5. The copying device of claim 1, wherein the zooming optical lens group consists of spherical or non-spherical lenses.

6. The copying device of claim 5, wherein the zooming optical lens group is a spherical lens, a convex-concave lens with double spherical surfaces; one spherical surface thereof has an R value of 8-80 mm, and the other has an R value of 8-80 mm; the central thickness is 0.5-5 mm; and the focal length is 30-90 mm.

7. The copying device of claim 6, wherein the convex-concave lens with double spherical surfaces is designed according to the focal length formula F=N*R1*R2/(N−1){N(R2−R1)+(N−1)D}, where F is the focal length, N is the index of refractivity nd of the lens, D is the central thickness thereof, and R1 and R2 are respectively the radii of the two spherical surfaces thereof

8. The copying device of claim 5, wherein the zooming optical lens group is aligned with the lens of the electronic device, the focal length is extended by 0.35±0.2 mm, the field angle changes from 66 degrees down to 48±5 degrees, the electronic device thus takes an image on the film of size 36 mm×24 mm at a distance of 41±5 mm from the film.

9. The copying device of claim 2, wherein the wide-angle optical lens group consists of spherical or non-spherical lenses.

10. The copying device of claim 9, wherein the wide-angle optical lens group is aligned with the lens of the electronic device, the focal length is shortened by 10%-20%, the field angle changes from 66±2 degrees to 80±20 degrees, and the aberration is within ±10%, so that the electronic device takes a photo of size 7 in.×5 in. at a smaller distance of 128±20 mm than the original 168 mm.

11. The copying device of claim 2, wherein the photo clip has a magnet and an L-shaped fixing plate, and the fixing plate is attracted onto the magnet to fix photos of different sizes.
